(19) United States
(12) Patent Application Publication
(10) Pub. No.: US 2009/0134655 A1
(43) Pub. Date: May 28, 2009

(54) Motorcycle wind deflector accessory support

(76) Inventor: Carl Paluszkiewicz, Mississauga (CA)

Correspondence Address: Douglas Eggins;c/o Kozlowski & Company, 5065 Forest Hill Drive, Mississauge, ON, L5M 5A7, CA

(21) Appl. No.: 12/219,921

(22) Filed: Jul. 30, 2008

(30) Foreign Application Priority Data
Oct. 29, 2007 (CA) 2,608,561

(51) Int. Cl. B62J 17/00; B62J 11/00

(52) U.S. Cl. 296/78.1

(57) ABSTRACT

A motorcycle wind deflector accessory support for attaching one or more motorcycle accessories to the accessory support. The accessory support has one or more support members forming a substantially rigid support structure contoured to correspond to at least a portion of the shape of a front surface of a wind deflector. The support structure defines at least one window through which at least a part of the front surface of the wind deflector is visible, together with an attaching structure that holds the support structure against or over at least a section of the front surface of the wind deflector. The accessory support may have a base for attachment to the motorcycle and/or may engage an exposed edge of the wind deflector. The accessory support may also have one or more rear support elements for supporting accessories. Accessories include decorative overlays for a front surface of the wind deflector, radio antennas, lighting, and reflectors.

### FIELD OF THE INVENTION

The present invention relates generally to motorcycle accessories. More particularly, the present invention relates to a motorcycle accessory support securable about a motorcycle wind deflector and accessories attachable to the support.

### BACKGROUND OF THE INVENTION

In the construction of some styles of motorcycles, such as Harley Davidson™ FLHT™ models, fibreglass shells known as fairings are placed over the front of the motorcycles to reduce drag and protect internal components. A front fairing and inner fairing may be secured together to and over the steering assembly. Notably, the fairings protect the rider and historically have supported a transparent windshield extending upward from the top of the fairings.

In modern motorcycle models, the windshield is often replaced by a wind deflector that extends upward only enough to deflect some of the air flow over and around the rider. Such designs avoid placement of a physical barrier immediately in front of the rider, and the deflector is therefore not required to be transparent. For aesthetic reasons the wind deflector is often black.

Motorcycle enthusiasts desiring to personalize their motorcycles may purchase or custom-design various functional or decorative motorcycle accessories, including decals, detailing, reflectors, lights, antennas and the like. Unfortunately, many of these custom modifications are irreversible or difficult to remove as the owner's needs or tastes change. Similarly, the owner may decide to sell the motorcycle and may wish to remove these accessories to bring the motorcycle back to stock looks. It is, therefore, desirable to provide motorcycle accessories that may be easily attached to and removed from the motorcycle without permanent alteration to the motorcycle.

Motorcycle enthusiasts often go to great expense to decorate or detail their motorcycles, including the front fairing and/or fuel tank, in various themes such as flames. Such artwork is typically not permanently extended above the front fairing onto the wind deflector, as this may damage the wind deflector or prevent restoration of the wind deflector. The result is often a wind deflector which has conflicting design features from that of the front fairing directly below the wind deflector of a modern motorcycle. While decorative pieces in the shape of upwardly rising flames have been developed for placement over a wind deflector for attachment between the wind deflector and a rear surface of a front fairing, the loose ends of the flames are subject to deforming over time, as well as easy vandalism and may rattle against the wind deflector. Accordingly, a better way to support a decorative piece against a wind deflector without modifying the wind deflector itself is desirable.

Modern motorcycles, especially “fully loaded” models such as Harley Davidson™ motorcycles, often have AM/FM radios as built in accessories. Antennas for AM/FM radios, especially FM band radios, require an antenna for suitable reception. These antennas are typically mounted as far away from the engine as possible and as high as possible for optimum reception. As a result vertical antennas are often mounted behind the rear seat of a motorcycle. This method of mounting an antenna makes the antenna prone to damage, vandalism and theft. Rear mounted vertically oriented antennas also require the occupant, especially a rear occupant, to swing his or her leg around the antenna making mounting and dismounting awkward. Accordingly, an improved method of supporting a radio antenna on a motorcycle is desirable.

Street motorcycles, as opposed to off road motorcycles or “dirt bikes”, are required to have turn signal lights, a rear brake light, and may have running lights. The rear turn signal lights and rear brake light or lights are typically mounted low on a motorcycle, typically below the rear seat of the motorcycle. Accordingly, the driver of a motor vehicle passing the motorcycle may not be able to see the motorcycle's rear brake or signal lights. This is especially a problem when the passing vehicle is in a motorcycle driver's blind spot, or when a motor vehicle is simply travelling in the motorcycle driver's blind spot. Some late model motorcycles sometimes have options for signal lights combined with side view mirrors, however, adding such mirrors after purchase is prohibitively expensive. Further, such mirrors may not be available as a retrofit for older models of motorcycles, and if available are extremely costly. Further, such additions are intended as permanent accessories for the motorcycle. Accordingly, an inexpensive and simple way to removably mount brake, turn signal, and running lights forward of the motorcyclist as high as possible on the motorcycle is desirable.

### SUMMARY OF THE INVENTION

In accordance with the present invention a motorcycle wind deflector accessory support is provided for attaching one or more motorcycle accessories to the accessory support, the accessory support having one or more support members forming a substantially rigid support structure contoured to at least a shape of a front surface of a wind deflector, the support structure defining one or more windows through which at least a part of the front surface of the wind deflector is visible, and having means for holding the support structure against or over at least a section of the front surface of the wind deflector.

In one aspect the support structure consists of one continuous support member defining one or more windows.

In one aspect the means for holding the support structure against or over the section of the front surface of the wind deflector includes a base attached to a bottom of the support structure, the base for attachment to the motorcycle. The base may be secured to the motorcycle by the same means as that securing the wind deflector to the motorcycle.

In one aspect, the means for holding the support structure against or over the section of the front surface of the wind deflector includes engaging means for engaging an upper edge of the wind deflector. In this aspect, the engaging means may be used together with, or in place of, the base.

In one aspect, the engaging means includes a channel defined by a back surface of an upper front support member, and a back surface of an upper rear support element, the upper support member and the upper support element connected to form a U-shaped channel.

In one aspect, the one or more rear support element is contoured to the shape of a rear surface of the wind deflector.

In one aspect, the one or more upper support members and the one or more rear support elements defining the channel for engaging the upper edge of the wind deflector includes a continuous upper support member and a continuous rear support element.

In one aspect the motorcycle wind deflector accessory support further includes one or more motorcycle accessories.

In another aspect the motorcycle accessory includes one or more decorative overlays attached to the support structure for display against or over the wind deflector within the one or more windows.

In one aspect the decorative overlay is attached to the support structure at two or more points.

In this aspect at least one of the two or more points is along an upper support member and another of the two or more points is along a lower support member.

In one aspect the decorative overlay attached to the upper support member and the lower support member is oriented vertically.

In one aspect the decorative overlay is attached to the support structure at three or more points defining three or more windows.

In one aspect the decorative overlay is integral with the support structure.

In one aspect the decorative overlay comprises one or more inserts which are removable and interchangeable.

In one aspect the decorative overlay is a contrasting colour from the front surface of the wind deflector.

In one aspect the decorative overlay is a contrasting colour from the support structure.

In another aspect the decorative overlay may also comprise a front support member.

In another aspect the motorcycle accessory includes an antenna.

In one aspect the antenna may be for an FM radio, AM radio, AM/FM radio, Citizen's band radio, private frequency two way radio, global positioning system (GPS), or for an ONSTAR™ communications and remote control system.

In one aspect the antenna is integral to or within the support structure, the one or more front support members, the one or more rear support elements, the base, or the edge of the accessory support over the upper edge of the wind deflector, or a combination thereof.

In one aspect the antenna may be attached to a surface of the accessory support, or be located within a groove in the surface of the accessory support, or be located within a cavity or channel in the accessory support, or a combination thereof.

In one aspect the antenna is attached around a perimeter of the accessory support or a perimeter of the support structure or a perimeter of the rear support elements, or a combination thereof.

In another aspect the motorcycle accessory includes decorative or functional, or decorative and functional, lights attached to any visible surface of the accessory support including the support structure, base, front support members, rear support elements and edge of the accessory support over the upper edge of the wind deflector.

In one aspect the lights are decorative and/or functional lights comprising one or more brake lights, one or more pair of turn signal lights, or one or more running lights, which are connected to and powered by the motorcycle's existing electrical system wherein the brake lights, turn signal lights and running lights attached to the accessory support operate simultaneously with and are controlled by the motorcycle's existing lighting system.

In one aspect the brake lights and turn signal lights are attached to the one or more rear support elements and spaced apart horizontally and running lights and turn signal lights are attached to the support structure and spaced apart horizontally.

In one aspect the brake lights, turn signal lights and running lights comprise Light Emitting Diode (LED) panels. The LED panels may be attached to the surface of the accessory support, including the support structure, front support members, base, rear support elements or edge of the accessory support over the upper edge of the wind deflector, or may be recessed in the support structure front support members, base, rear support elements or edge of the accessory support over the upper edge of the wind deflector.

In one aspect other decorative and/or functional lights may be attached to the accessory support which may be powered by the motorcycle's existing electrical system or may have a separate power source which may include one or more batteries. The lights may also be connected to means for regulating the order, frequency, intensity and colour of the lights to be powered.

In another aspect the motorcycle accessory includes one or more reflectors attached to the visible surface of the accessory support including the support structure, front support members, base, rear support elements, and edge of the accessory support over the upper edge of the wind deflector.

Other aspects and features of the present invention will become apparent to those ordinarily skilled in the art upon review of the following descriptions of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is an exploded perspective assembly view of a motorcycle wind deflector accessory support mounted on a wind deflector on a motorcycle;

FIG. 2 is a sectional side view of the assembly of FIG. 1 taken along line 2-2.

FIG. 3 is a front view of the accessory support without a wind deflector accessory attached to the support shown mounted on a wind deflector;

FIG. 4 is a rear view of the support of FIG. 3 without a wind deflector accessory attached to the support shown mounted on a wind deflector;

FIG. 5 is a front view of the accessory support with a decorative overlay supported by an upper and a lower support member of the support structure;

FIG. 6 is a rear view of the accessory support with the decorative overlay of FIG. 5 supported by the upper and lower support members of the support structure;

FIG. 7 is a front view of the accessory support with multiple decorative overlays supported by upper and lower support members of the support structure and defining a plurality of windows.

FIG. 8 is a front view of the accessory support with a single decorative overlay attached at multiple points along the support structure and defining a plurality of windows.

FIG. 9 is a front view of the accessory support shown supporting a radio antenna;

FIG. 10 is a rear view of the accessory support shown supporting the radio antenna of FIG. 9;

FIG. 11 is a front view of the accessory support shown supporting left and right running lights and left and right turn signal lights;

FIG. 12 is a rear view of the accessory support of FIG. 11 shown supporting left and right brake lights and left and right turn signal lights; and

FIG. 13 is a schematic view of a wiring harness for the lights of FIG. 11 and FIG. 12.

### DETAILED DESCRIPTION OF THE EXEMPLARY EMBODIMENTS

Generally, the present invention provides a motorcycle wind deflector accessory support 30 attachable against a motorcycle wind deflector 25 for supporting various motorcycle accessories. Exemplary embodiments are discussed below with reference to the figures.

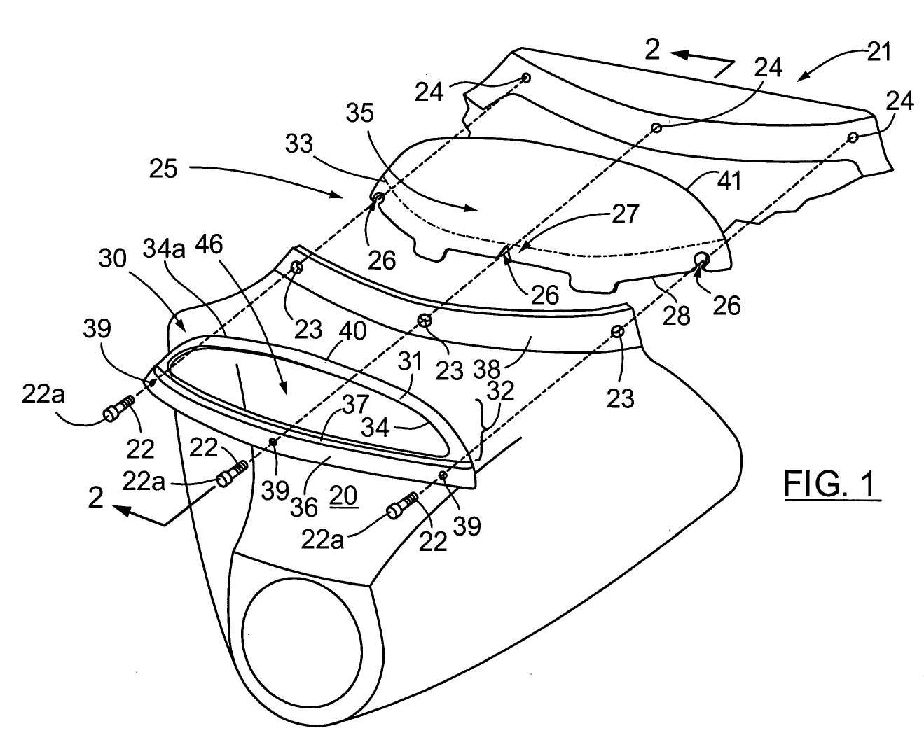

With reference to FIG. 1, at least a portion of the steering assembly of many modern motorcycles are encased between a front fairing 20 and an inner fairing 21. The front fairing 20 is typically attached to the forks (not shown) of a motorcycle steering assembly and typically supports a headlight and is generally shaped to deflect wind resistance around a motorcyclist. The inner fairing 21 typically comprises a dashboard which typically supports various gauges and dials, a radio and the like. The wind deflector 25 extending upwardly from fairings 20, 21 is typically held in place by securing a bottom portion 27 of the wind deflector 25 between front fairing 20 and inner fairing 21. A bottom edge 28 of wind deflector 25 typically comprises mounting notches 26 or the bottom portion 27 may comprise mounting apertures (not shown) whereby a plurality of wind deflector attachment bolts 22, commonly three bolts 22, are passed through front fairing apertures 23, then through corresponding mounting notches 26 or mounting apertures (not shown) and then into corresponding threaded sleeves 24 or threaded nuts (not shown) supported by inner fairing 21 in order to secure the wind deflector 25 to the motorcycle (not shown).

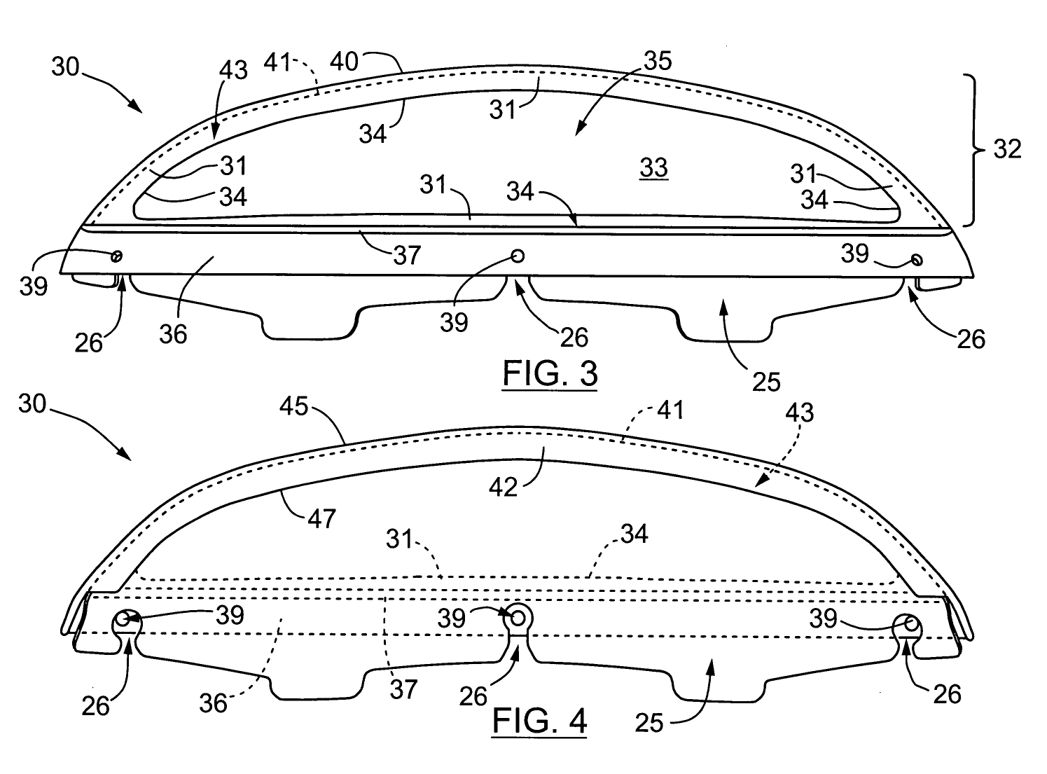

FIGS. 1 to 4 illustrate one embodiment, and variations thereof, of the present invention in which a motorcycle wind deflector accessory support 30 is provided comprising one continuous front support member 31 forming a substantially rigid support structure 32 contoured to the shape of a front surface 33 of wind deflector 25, the support member 31 for placement against the front surface 33 of the wind deflector 25, an inside edge 34 of front support member 31 surrounding a central unobstructed portion 35 of the front surface 33 of the wind deflector 25, the support structure 32 for supporting one or more than one motorcycle accessories. An integral base 36 is attached to support structure 32 by jog 37. Jog 37 is provided to accommodate the distance between the front surface 33 of wind deflector 25 and the front surface 38 of front fairing 20. Base 36 is attached to the front surface 38 of the front fairing 20 by wind deflector attachment bolts 22. Depending upon the model of motorcycle and the thickness of the base 36 existing bolts 22 may be used to secure the base 36 against the front surface 38 of fairing 20 but longer bolts 22 of a similar thread pattern may be substituted. Existing bolts 22 holding the wind deflector 25 in place are removed and existing or longer replacement bolts 22 with bolt heads 22a are installed through accessory support apertures 39 of accessory support 30, front fairing apertures 23 in front fairing 20, wind deflector notches 26 in wind deflector 25, respectively, and then threaded into threaded sleeves 24 which are supported by inner fairing 21. An upper portion 40, of an upper front support member 31 which is contoured to the shape of front surface 33 of wind deflector 25, adjacent an exposed edge 41 of wind deflector 25 is attached to an upper portion 45, of an upper rear support element 42 which is contoured to the shape of a rear surface 44 of wind deflector 25, adjacent to the exposed edge 41 of wind deflector 25, which defines channel 43 for engaging the exposed edge 41 of wind deflector 25 to more securely mount the support structure 32 against the front surface 33 of wind deflector 25. Upper rear support element 42 may be somewhat resilient and biased towards rear surface 44 of wind deflector 25 to snugly mount an upper portion of support member 31 against the front surface 33 of the wind deflector 25 to reduce or eliminate rattling. It is to be understood that the upper exposed edge 41 of wind deflector 25 is to be inserted into channel 43 before base 36 is bolted against front fairing 20.

The motorcycle wind deflector accessory support 30 may be constructed of any suitable material, including fibreglass, plastic, metal, PVC etc. Appropriate materials and design modifications should be considered to minimize drag and rattle of the support 30 against the wind deflector 25 while driving, depending on the desired material for the accessory support 30. For example, it is expected that rattle could be minimized by using a low-profile fibreglass support structure 32, or by securing one or more of the front support members 31 to upper exposed edge 41 of the wind deflector 25. Similarly, any windows 46 within the support structure 32 may be filled with clear plastic to protect the visible front portions of the wind deflector 25 and reduce drag.

Several alternate ways exist to attach the base 36 to the motorcycle. For example the base 36 may be compressed between a back surface (not shown) of front fairing 20 and the front surface of wind deflector 25 in which case accessory support apertures 39 may, but need not be used, as compression exerted by front fairing 20 against base 36 on tightening wind deflector attachment bolts 22 would be enough to hold the base 36 securely in place. However, depending upon the contour of the bottom edge of base 36 notches similar to notches 26 in wind deflector 25 may be used to allow bolts 22 to be installed. In this example a jog would not be required to join the support structure 32 to base 36 as both the support structure 32 and the base 36 would be co-planer and lay against the front surface 33 of wind deflector 25. It is to be understood that support structure 32 need not necessarily comprise a lower support member above base 36 as jog 37 and base 36 or jog 37 may comprise a lower portion of support structure 32.

Another example of an alternate way to mount base 36 would be to compress base 36 against the front surface 38 of front fairing 20 using a piece of trim (not shown), usually chrome plated metal. The trim would typically have apertures which would support the heads 22a of bolts 22 which bolts 22 would pass through apertures in the trim, typically three or five apertures in most Harley Davidson™ FLHT™ models, then through accessory support apertures 39 or accessory support notches (not shown) of base 36 of accessory support 30, then through notches 26 or apertures (not shown) in wind deflector 25, and then into threaded sleeves 24 or nuts (not shown) supported by inner fairing 21. In this example the jog 37 would usually be retained as a way to seat the support structure against the front surface 33 of wind deflector 25.

Many other ways of attaching support structure 32 to the front surface 33 of wind deflector 25 exist. These may include more temporary methods such as using two-way tape to hold the support structure 32 against the front surface 33 of wind deflector 25. More permanent ways of attaching accessory support 30 to a motorcycle may include gluing, welding, riveting, fastening, bolting, etc. Many other ways of securing the base 36 of the motorcycle wind deflector accessory support 30 to a motorcycle will be possible depending on the construction of the motorcycle, which may or may not utilize a front fairing or inner fairing. If a motorcycle has a wind deflector 25 there would usually be a mechanism to secure the bottom edge of the wind deflector to the motorcycle to which the base 36 may be secured in an analogous manner.

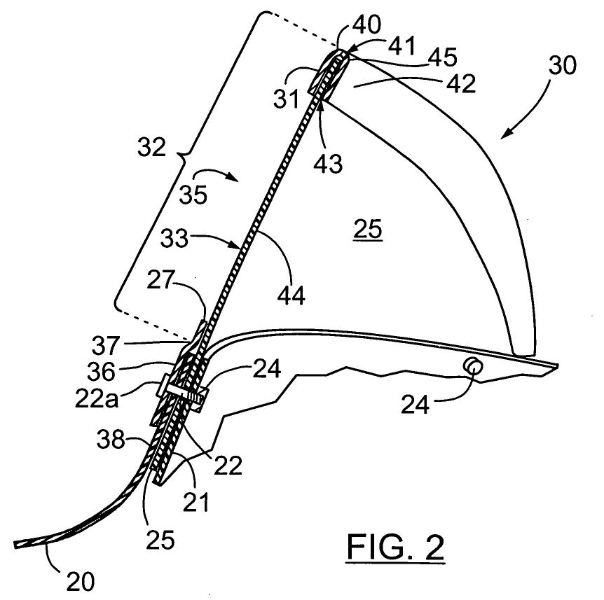

In another embodiment the means for holding the support structure 32 against the front surface 33 of the wind deflector 25 comprises at least one engagement member or engaging means for the support structure 32 to engage an upper exposed edge 41 of the wind deflector 25. The engaging means may be used alone or together with base 36. In the embodiment shown in FIG. 2, accessory support 30 includes a U-shaped channel 43 for engaging an upper exposed edge 41 of the wind deflector 25. The U-shaped channel 43 may be continuous along a length of the upper exposed edge 41 of wind deflector 25, or the U-shaped channel may be used discontinuously at one or more points along exposed edge 41 resulting in a plurality of channels 43. The U-shaped channel 43 may comprise one or more rear support elements 42 which may, but need not, be resilient. The U-shaped channel 43, with or without one or more rear support element 42, may engage exposed edge 41 via a friction fit, with or without a resilient gasket (not shown). Alternatively, a side of the U-shaped channel 43, presumably a side of channel 43 adjacent the rear surface 44 of wind deflector 25 for aesthetics, may be fitted with one or more set screws (not shown) for compression against the rear surface 44 wind deflector 25. If a U-shaped channel 43 is to be used with base 36, U-shaped channel or channels 43 would usually be installed over exposed edge 41 before securing base 36 to the front fairing 20 or other support on different constructions of motorcycles. Alternatively, the U-shaped channel 43 may be flexible for stretching over and snugly engaging a portion of exposed edge 41 of wind deflector 25. U-shaped channels 43 may be replaced with clips, clamps or other means to secure support structure 32 to the front surface 33 of wind deflector 25 proximate exposed edge 41.

In embodiments in which the wind deflector 25 is engaged by a channel 43 or clip of the accessory support 30, the clip or channel 43 should resist slippage from the wind deflector 25 in order to remain secure when the motorcycle is driven, unless the bottom of the support structure 32 is secured by the use of base 36 or other device not reliant upon anti-slippage means in channel 43. For example, when the accessory support 30 includes a U-shaped channel 43 for engaging an exposed edge 41 of the wind deflector 25, the U-shaped channel 43 may be resiliently biased to grip the front surface 33 of wind deflector 25 or rear surface 44 of wind deflector 25, or both, and at least one inner surface of the U-shaped channel 43 may further bear an abraded surface for gripping the front surface 33 or rear surface 44 of wind deflector 25. As such, a certain amount of force may be applied to the U-shaped channel 43 to overcome the bias of the channel 43 when securing the channel 43 over the exposed edge 41 of wind deflector 25.

This attachment of the accessory support 30 to the wind deflector 25 along edge 41 of the wind deflector 25 may be sufficient to secure the accessory support 30 against the wind deflector 25 without need for base portion 36. It is, however, expected that inclusion of a securable base 36 will provide additional security and integrity. It is expected that maximum security of the accessory support 30 against the wind deflector 25 will reduce drag and rattle of the accessory support 30 against the wind deflector 25, when the motorcycle is driven at high speeds.

Alternatively, support structure 32 may comprise a plurality of separate front support members 31, which may be held against front surface 33 of wind deflector 25 by the same or different means. For example, a lower support member 31 may be held in place by a base 36, while an upper support member 31 may be held in place by a channel 43. Support structure 32 may comprise front support members 31 which are separated from one another or that overlap for continuity or strength. Part of a visible portion or portions of the front surface 33 of wind deflector 25 may be within the one or more than one windows defined by the inside edges 34 of front support members 31, and part of the visible portion or portions of the front surface 33 of wind deflector 25 may be between outside edge 34a of support structure 32 and exposed edge 41.

While accessory support 30 is primarily intended to be removably attachable to wind deflector 25, it need not be. Accessory support 30 may also be attached to wind deflector 25 in more permanent manners such as gluing, heat welding, bolting, riveting, screwing, clamping, etc. However, when accessory support 30 is removably attachable, different accessory supports 30 may be installed with different accessories, different configurations of front support members 31 or rear support elements 42, or in different colours. For example a black support structure 32 may be used to blend in with a typically black wind deflector 25 or a different colour to create contrast.

With reference to FIGS. 1 and 2, in order to install the motorcycle wind deflector accessory support 30 having base 36 with jog 37 and channel 43 against wind deflector 25 on a motorcycle, the original wind deflector attachment bolts 22 with heads 22a holding the wind deflector 25 to the motorcycle are first removed. The accessory support 30 is then slid over top of wind deflector 25 such that channel 43 snugly engages exposed edge 41 of wind deflector 25. The accessory support apertures 39 are then aligned with front fairing apertures 23 followed by wind deflector mounting notches 26, followed by threaded sleeves 24 supported by inner fairing 21. Bolts 22 are then placed through the aligned apertures and notches 39, 23, 26, respectively, and bolted into the threaded sleeves 24, thereby holding the accessory support 30 against the wind deflector 25 using the original hardware provided by the manufacturer, or using longer bolts if necessary. The accessory support 30 may similarly be removed as desired by the owner without damage or physical modification to the wind deflector 25 or motorcycle.

Accessory support 30 is provided for supporting a number of motorcycle accessories. These accessories may include, but are not limited to, various decorative overlays and/or inserts as well as various antennas for various radio and communication devices and brake, turn signal, and running lights and other lighting, and reflectors.

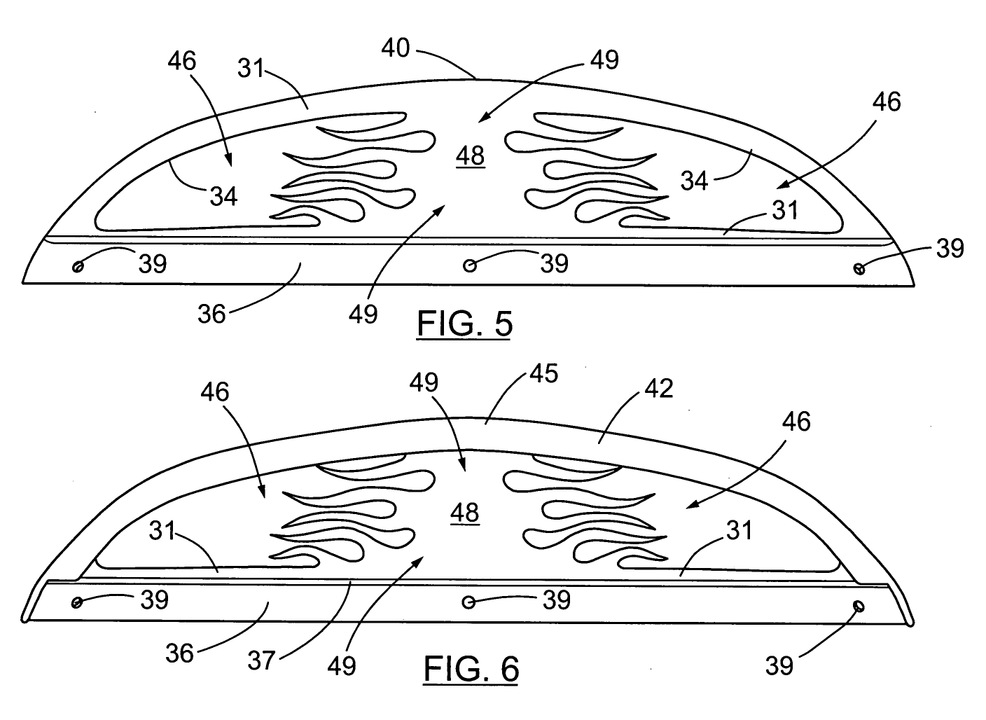

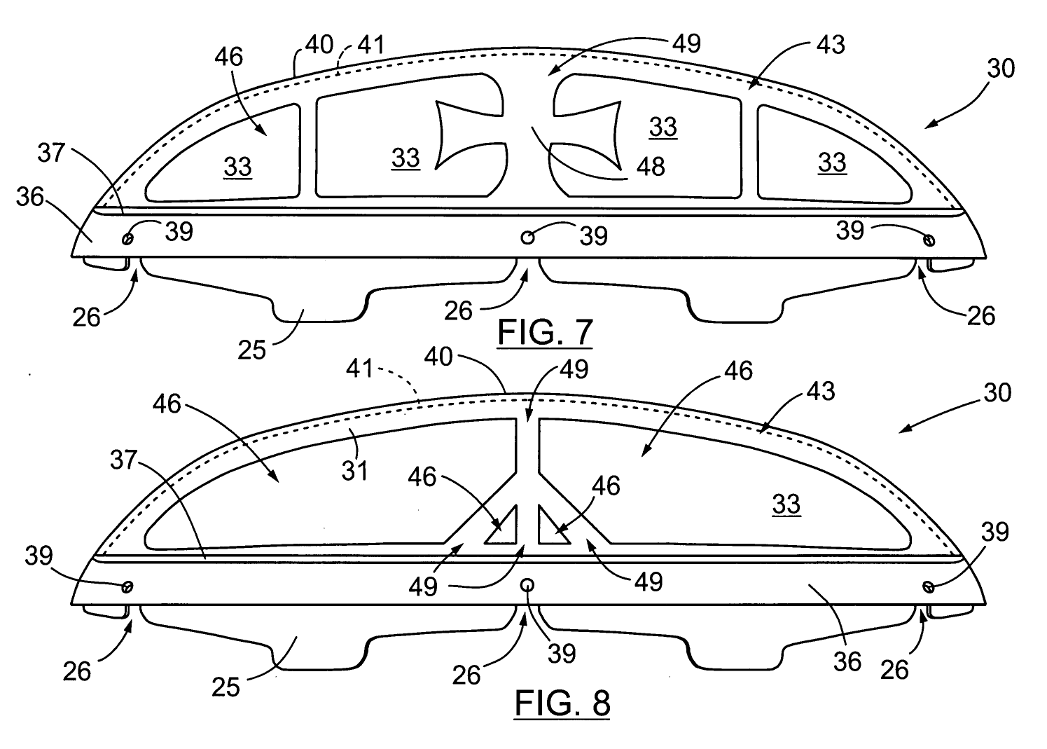

One type of accessory that may be used with accessory support 30 is a decorative overlay 48 (FIGS. 5-10) or insert (not shown). Exemplary embodiments of decorative overlays 48 are shown in FIGS. 5 to 10. Decorative overlays 48 are provided in various shapes and sizes for placement over a usually dark coloured, typically black, wind deflector 25 in order to extend the theme of detailing on a motorcycle, notably detailing on the front surface 38 of the front fairing 20. The theme may comprise common motorcycle art such as flames, or crosses, or the theme may be a custom one. The overlay 48 need not correspond to an existing theme or colour on the motorcycle, however, the colour or colours of the decorative overlay 48 would typically be a colour contrasting with black, or other wind deflector 25 colour, such that the design of the decorative overlay 48 is visible to oncoming traffic and pedestrians against the wind deflector 25. Various effects may be created by varying the shape and colour of the overlay 48 relative to the shape and colour of the wind deflector to provide a suitable contrast. A black, or other colour of support structure 32 matching the colour of the wind deflector 25, may be used so that the support structure 32 blends in with the wind deflector 25 to approximate stock looks and give prominence to decorative overlay 48. It is to be understood that the decorative overlay may be the same colour, and not necessarily a contrasting colour, as the wind deflector for a more subtle effect. The accessory support 30 may be the same or different colour or colours as the colour or colours of the decorative overlay 48. Base 36 may be the same colour as the rest of the accessory support 30 or may be of a different colour such as a colour complementary to the colour or colours of the front surface 38 of front fairing 20.

The one or more decorative overlays 48 extend over the front surface 33 of the wind deflector 25 within a window 46 and are attached to the support structure 32 at two or more points of attachment 49. A central window 46 defined by the outside support members 31 of the support structure 32 may also be divided into two or more smaller windows 46 by an overlay 48 attached to support structure 32 at two or more points of contact around the central window 46 defined by the outside support members 31 of the support structure 32.

Decorative overlays 48 may be integral to the support structure 32. For example, the overlay 48 and support structure 32 may both be manufactured into a single component using materials such as fibreglass, plastic, metal, PVC, etc. Alternatively, the overlay 48 and support structure 32 to which the overlay is to be attached may be made separately, of similar or different materials, and permanently joined together, The overlay 48 and the support structure 32 may be manufactured at the same time or at different times and subsequently permanently joined together. Different pieces may be permanently joined together in various ways including fastening, bonding, gluing, welding, screwing, bolting, riveting, fiberglassing, and other ways known in the art.

Alternatively, overlays 48 may be removably attachable to support structure 32 and overlays 48 may be interchangeable. Overlays 48 may be attached to support structure 32 in various ways including bolting, screwing, snaps, clips, magnets, friction, hook and loop fasteners, two sided tape and other ways known in the art. Overlays 48 may for instance comprise inserts which snap into a window 46. Alternatively, overlays 48 may be held in place by the rear surface of support structure 32. For example the insert may be larger than the window 46 into which the insert is to be placed. In one embodiment a rear edge of the window 46 may comprise a track to recess the insert in the back of the support structure 32 defining the window 46 so that the support structure 32 may still be flush mounted against the front surface 33 of wind deflector 25 and to prevent the insert from shifting. Removably attachable overlays 48 will usually be rigid so that the overlay will remain in position, but exceptions may exist.

It is also to be understood that a portion of a decorative overlay attached to an upper support member and a lower support member may also function as a support member for portions of the decorative overlay supported at one end by the support structure and at another end by the said portion of the decorative overlay as shown in FIG. 8.

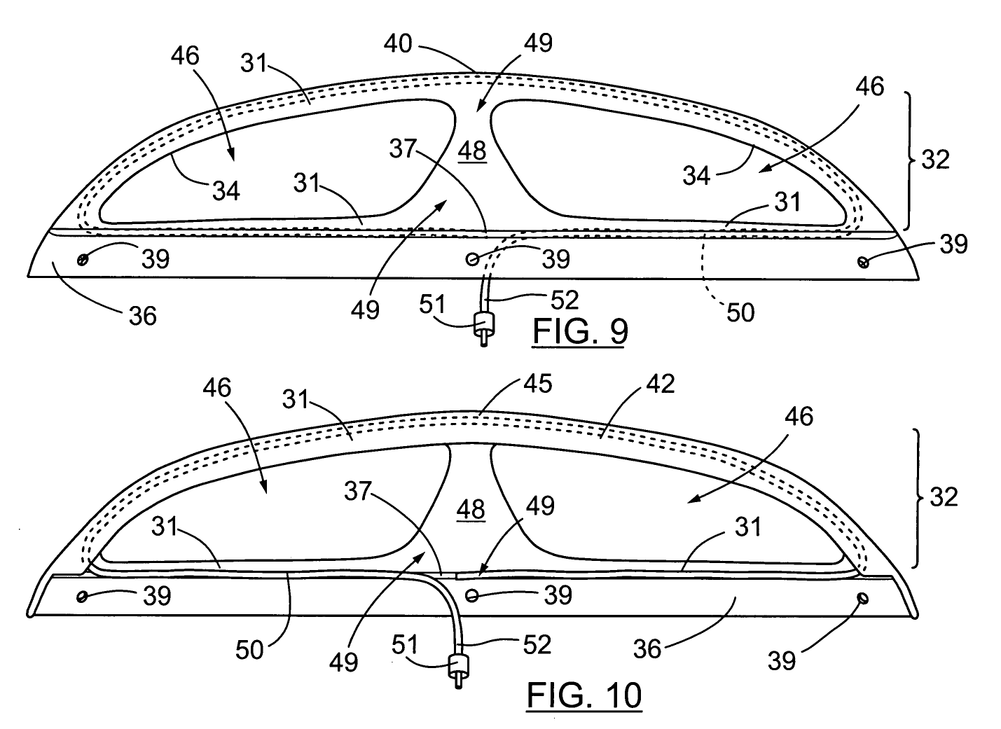

Another accessory that may be used with the accessory support 30 comprises an antenna 50, such as shown in FIGS. 9 and 10. The antenna 50 may be for an FM, AM, AM/FM, Citizen's band, or private frequency two way radio, or a global positioning system (GPS), or an ONSTAR™ communications and remote control system or any other automobile accessory requiring an antenna 50. The antenna 50 may be mounted within the accessory support 30 or on the surface of the accessory support 30, or a combination of such mounting methods, including, but not limited to, on or within the support structure 32, base 36, front support members 31, and rear support elements 42.

In one embodiment the antenna 50 is integral to the accessory support 30. For example, the antenna may be moulded into the accessory support 30. The antenna 50 also may be located within a cavity in the accessory support 30 and may be removeably attachable to the accessory support 30 so as to be able to replace the antenna 50 in the event that repairs are required, or if an antenna 50 with different properties is required if the technology associated with the accessory changes, or if an antenna 50 for a different accessory is desired. Further, multiple antennae 50 may be mounted in the accessory support for different accessories, or for different reception required within the same accessory. More than one antenna 50 may be mounted in the same or different manners. Different antennae 50 may need to be spaced apart and may be mounted in different manners to achieve this. Alternatively, multiple cavities may be provided, in the same or different parts of the accessory support 30. Accordingly, multiple cavities may be provided parallel or side-by-side. Alternatively, the antennae 50 may be coated with an interference inhibiting coating or one or more of the antennae 50 may each be fitted within a tube of interference inhibiting material. One or more grooves or troughs may also be provided for recessing the antennae 50 from surfaces of the accessory support 30. Where it is desirable to surface mount the one or more than one antenna 50 the one or more grooves or troughs may be useful to provide a flush surface or simply for aesthetics. For example, grooves or troughs may be provided along an inner surface of channel 43 or along the back surface of support structure 32 or along the back surface of one or more support element 42 such that wind deflector 25 may be mounted flush against such grooves or troughs, thus holding the antenna 50 in place. The antenna 50 may also be kept in place within the troughs for ease of mounting the antenna 50, for example by tape or by a friction fit or by a snap fit or by bonding, such as with glue, epoxy, silicone, or other methods. Thus the antenna 50 may be removed from the grooves or troughs in the accessory support 30 if necessary and a replacement or other antenna 50 installed if desired. If grooves or troughs are in a visible location the grooves or troughs may be filled with a bonding agent or filler, such as auto body filler, and painted. The antenna 50 may be recessed from the surrounding surface of the accessory support 30, the one or more front support members 31, the one or more rear support elements 42, or the base 36, or a combination thereof.

In various embodiments the antenna 50 can be attached around a perimeter of the accessory support 30 or a perimeter of the support structure 32 or a perimeter of the one or more than one rear support element 42 or a perimeter comprising the base 36, or a combination thereof, in order to spread out the antenna 50. An antenna 50 may also be too long to fit around a perimeter of the accessory support 30 in which case the antenna 50 may overlap itself, usually, but not necessarily, in a spaced apart relationship.

FIGS. 9 and 10 depict the motorcycle wind deflector accessory support 30 with a radio antenna 50 attached thereto. In the embodiments shown, a FM dipole antenna 50, with each wire of the dipole run in parallel, is attached with tape (not shown) to the back of the wind deflector 25 adjacent the top edge of the inner fairing 21 (not shown) from approximately the horizontal center of the accessory support 30. The antenna 50 is then run inside channel 43 from one side of the accessory support 30 to the other. The antenna 50 is then attached with tape to the back of the wind deflector 25 adjacent the top edge of the inner fairing 21 (not shown) to approximately the horizontal center of the accessory support 30 where the antenna 50 is routed downwardly to the radio (not shown). In these embodiments each wire of the dipole is 33.75 inches, with 70-OHM capacity. The dipole antenna is connected to a 300 OHM ribbon cable 52 which is attached to an industry standard AM/FM radio male antenna jack 51. Or course, other antenna lengths and capacities are also contemplated.

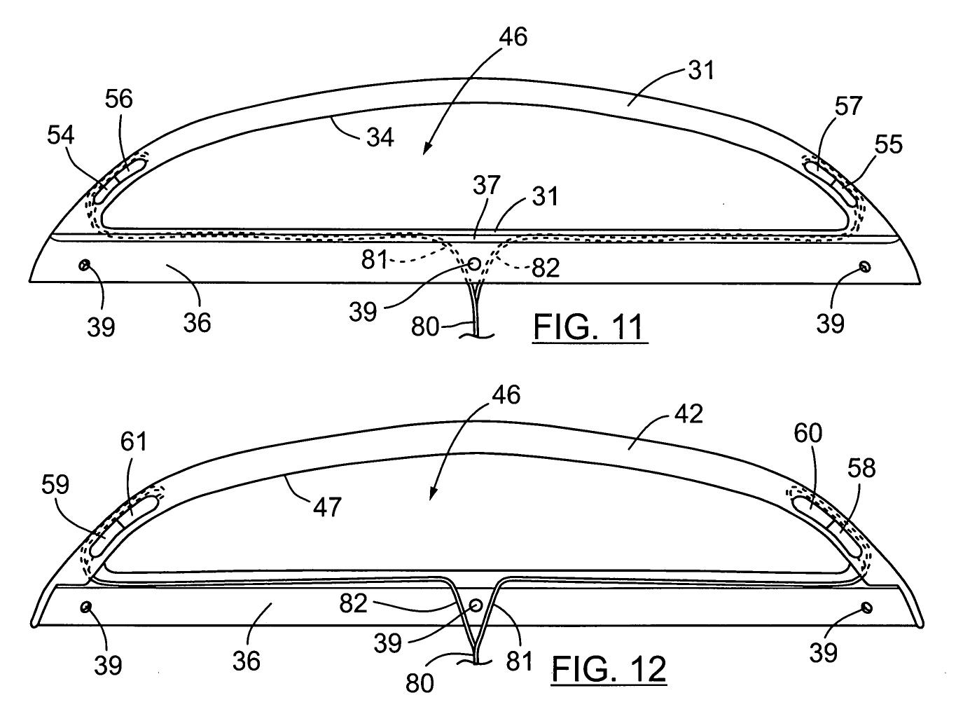

A further accessory that may be mounted on or in the motorcycle wind deflector accessory support 30 is a combination of automotive indicator lights comprising brake lights 60, 61, turn signal lights 54, 55, 58, 59 and running lights 56, 57, as shown in FIGS. 11 to 13. One will recognize that not all such lights need be utilized, but a combination of all such lights would be the most useful as well as the most decorative. While many different types of lights compatible with the motorcycle's electrical system may be used, Light Emitting Diode (L.E.D.) panels are preferred as such panels are available in thicknesses of approximately ⅛ of an inch which may be partly or fully recessed in accessory support 30 thus resulting in a flush profile or thinner profile than available with other lights. Further, LED panels draw minimal current therefore not burdening the motorcycle's electrical system. Further, LED lights rarely require replacement. LED lights are also generally available for twelve volt electrical systems such as used with most modern motorcycles, although they are also available in other voltages, for example six volt. Many larger modern motorcycles contemplate the use of auxiliary lighting and often have terminals specifically for auxiliary brake, turn and running lights. If such terminals are not available, those familiar with motorcycles, especially automotive electricians, would readily understand how to splice such auxiliary lighting into the existing wiring harness of a motorcycle. Such auxiliary Brake lights 60, 61 are most useful in rearward facing orientations, although one or more forward facing brake lights may be useful. For example a forward facing brake light or lights mounted on the front surface of the support structure 32, preferably centrally mounted along an upper support member 31, provides visibility high up on a motorcycle where mounting substrates are limited or non-existent, so that oncoming traffic may readily see when the motorcycle is slowing or stopping. Turn signal lights 54, 55, 58, 59 are useful in both rearward and forward facing orientations. Running lights 56, 57 are most useful in a forward facing orientation as rearward facing running lights may distract the motorcycle driver in night driving, although rearward facing applications are possible. Brake lights 60, 61 and running lights 56, 57 may be useful on any surface of the accessory support 30, but turn signal lights 54, 55, 58, 59 to be useful would require right turn signal lights 54, 58 to be attached to the right half of the accessory support 30 and left turn signal lights 55, 59 to be attached to the left half of the accessory support 30. Such lighting may also be used decoratively on any exposed surfaces of the accessory support 30 in random or repeating patterns mostly for the effect of lights going on and off. For example, the entire perimeter of the accessory support may light up when one or more of brake, turn and running lights are engaged by the driver, without necessarily indicating the direction of a turn in the case of turn signals.

FIGS. 11 to 13 show embodiments of a wind deflector mounted auxiliary lighting system. FIG. 11 is a front view of the accessory support 30 receiving a main auxiliary wiring harness 80 which divides into right wiring sub-harness 81 supplying power to right front turn signal light LED panel 54 and right front running light LED panel 56 and right rear brake light LED panel 60 (not shown in FIG. 11 but shown in FIG. 12) and right rear turn signal light LED panel 58 (not shown in FIG. 11 but shown in FIG. 12), and divides into left wiring sub-harness 82 supplying power to left front turn signal light LED panel 55 and left front running light LED panel 57 and left rear brake light LED panel 61 (not shown in FIG. 11 but shown in FIG. 12) and left rear turn signal light LED panel 59 (not shown in FIG. 11 but shown in FIG. 12). FIG. 11 shows LED panels 54, 56, 55, 57 recessed in the horizontally right and left ends of upper front support member 31. FIG. 12 shows LED panels 58, 60, 59, 61, recessed in the horizontally right and left ends of upper rear support element 42. Wiring sub-harnesses 81, 82, are shown attached to the rear surface of jog 37 then travelling in channel 43 (not shown) to the right to LED panels 54, 56, 58, 60, and to the left to LED panels 55, 57, 59, 61. LED panels 54 to 61 may be secured to supports 31, 42 by any number of ways including, integrating during manufacture of accessory support 30, gluing, a friction fit, a snap fit, bolting, screwing, riveting, and other ways known in the art.

Those skilled in the art will recognize that many ways of routing the harnesses 80, 81, 82 to the lighting are possible and the precise route the wiring takes to reach the LED panels is not critical. A wiring harness or other such wiring directly from the motorcycle's electrical system to the LED panels 54 to 61 may not even be necessary. The LED panels 54 to 61 requiring minimal power may also have their own power supply, for instance a battery, attached to or proximate the LED panels 54 to 61, together with RF receivers connected to the LED panels 54 to 61 for receiving signals from RF transmitters connected to the motorcycle's auxiliary power terminals, or equivalent splicing into the motorcycle's existing wiring system. A different set of RF receiver, transmitter and frequency, could be used for each different type of signal (i.e. Brake, right turn and left turn signals). Those skilled in the art, especially motorcycle electricians, will know how to connect well known RF parts in the required manner. Running lights may simply have their own power source with a simple on-off switch independent of the motorcycle's electrical system.

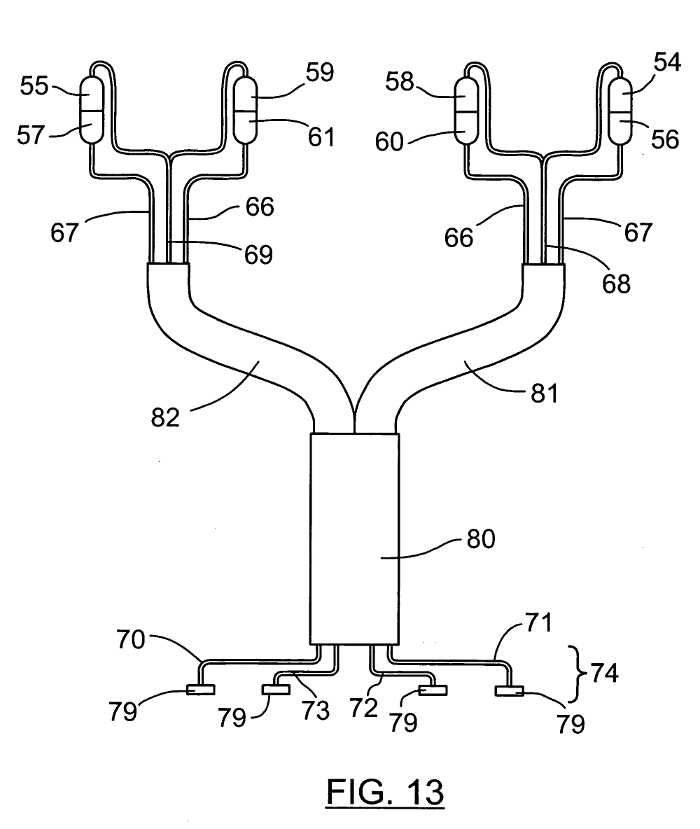

FIG. 13 is a schematic view of LEDs 54 to 61 and wiring harnesses 80, 81, 82. Power for the wind deflector auxiliary lighting system is typically obtained from the motorcycle's power terminals (not shown). Accessory panel connection wires 74 comprising brake accessory panel wires 70, running lights accessory panel wires 71, right signal lights accessory panel wires 72 and left signal lights accessory panel wires 73, each terminate with an accessory panel connector 79 for connecting to the auxiliary power terminals of the motorcycle. Each accessory panel connector 79 may be removed for splicing the wires into the motorcycle's existing wiring harness if required. Connection wires 74 are then bound together to form main auxiliary wiring harness 80 which splits into right wiring sub-harness 81 and left wiring sub-harness 82 proximate accessory support 30. Brake light power from brake accessory panel wires 70 and main harness 80 is split and delivered through sub-harnesses 81, 82 and right and left brake light wires 66 to right rear brake light LED panel 60 and left rear brake light LED panel 61. Running light power from running lights accessory panel wires 71 and main harness 80 is split and delivered through sub-harnesses 81, 82 and right and left running light wires 67 to right front running light LED panel 56 and left front running light LED panel 57. Right turn signal light power from right signal lights accessory panel wires 72 and main harness 80 and right wiring sub-harness 81 and front and rear right signal light wires 68 is split and delivered to right front turn signal light LED panel 54 and right rear turn signal light LED panel 58. Left turn signal light power from left signal lights accessory panel wires 73 and main harness 80 and left wiring sub-harness 82 and front and rear left signal light wires 69 is split and delivered to left front turn signal light LED panel 55 and left rear turn signal light LED panel 59.

Decorative lights may be attached to any visible surface of the accessory support 30 which may be powered by the motorcycle's existing electrical system or may have a separate power source which may comprise one or more batteries. The decorative lights may also be connected to means for regulating the order, frequency, intensity and colour of the lights to be powered, as well as means for turning the lights on and off.

The support structure 32, base 36, front support members 31 and rear support elements 42 may also comprise reflectors which may be surface mounted, for example by two sided tape, or be recessed in the support structure 32, base 36, support elements 42 or be flush with the outside surface of the support structure 32, base 36, support members 31, or support elements 42 and be attached in the same manner as may the LED panels.

In this specification the terms left and right and horizontal and vertical are from the vantage point of a driver of a motorcycle.

The above-described embodiments of the present invention are intended to be examples only. Alterations, modifications and variations may be effected to the particular embodiments by those of skill in the art without departing from the scope of the invention.

### PARTS LIST

20. front fairing
21. inner fairing
22. wind deflector attachment bolts
22a. heads of attachment bolts
23. front fairing apertures
24. threaded sleeves
25. wind deflector
26. mounting notches (in wind deflector)
27. bottom portion (of wind deflector)
28. bottom edge of wind deflector
29. upper edge of wind deflector
30. motorcycle wind deflector accessory support
31. front support member
32. support structure
33. front surface (of wind deflector)
34. inside edge (of front support member)
34a. outside edges of support structure
35. central unobstructed portion (of front surface of wind deflector)
36. base
37. jog (connecting base to support structure)
38. front surface of front fairing
39. accessory support apertures
40. upper portion (of upper front support member)
41. exposed edge (of wind deflector)
42. rear support element
43. channel
44. rear surface (of wind deflector)
45. upper portion (of upper rear support element)
46. windows (in support structure)
47. edges of rear support element
48. decorative overlay
49. point of attachment (of overlay)
50. antenna
51. antenna jack (male)
52. cable
54. right front turn signal light LED panel
55. left front turn signal light LED panel
56. right front running light LED panel
57. left front running light LED panel
58. right rear turn signal light LED panel
59. left rear turn signal light LED panel
60. right rear brake light LED panel
61. left rear brake light LED panel
66. brake light wires (right rear and left rear)
67. running light wires (right front and left front)
68. right signal light wires (front and rear)
69. left signal light wires (front and rear)
70. brake lights accessory panel wires
71. running lights accessory panel wires
72. right signal lights accessory panel wires
73. left signal lights accessory panel wires
74. accessory panel connection wires
79. accessory panel connectors
80. main auxiliary wiring harness
81. right wiring sub-harness
82. left wiring sub-harness

What is claimed is:

1. A motorcycle wind deflector accessory support for attaching at least one motorcycle accessory to the accessory support, the accessory support comprising:
at least one support member forming a substantially rigid support structure contoured to correspond to at least a portion of a shape of a front surface of a wind deflector,
at least one window formed in said accessory support through which at least a part of the front surface of the wind deflector is visible, and
attaching structure that holds said support structure against or over at least a section of the front surface of the wind deflector.

2. The motorcycle wind deflector accessory support of claim 1 wherein said support member is continuous.

3. The motorcycle wind deflector accessory support of claim 1 wherein said attaching structure comprises a base attached to a bottom of the support structure for attachment to a motorcycle.

4. The motorcycle wind deflector accessory support of claim 3 wherein the base is attached to the bottom of the support structure by a jog for mounting the base against or over a front surface of a front fairing.

5. The motorcycle wind deflector accessory support of claim 3 wherein the base is co-planar with the support structure.

6. The motorcycle wind deflector accessory support of claim 3 wherein the base includes apertures or notches for attaching the base to a motorcycle, wherein the apertures or notches in the base correspond to apertures or notches in the wind deflector, and further wherein the base and the wind deflector are configured and arranged to be attached to a motorcycle with one or more bolts.

7. The motorcycle wind deflector accessory support of claim 3 wherein said attaching structure includes at least one engagement member that engages an upper edge of the wind deflector.

8. The motorcycle wind deflector accessory support of claim 7 wherein said engagement member comprises a channel.

9. The motorcycle wind deflector accessory support of claim 8 wherein said channel is defined by a back surface of an upper front support member and a back surface of an upper rear support element, wherein the upper support member and the upper support element are connected to form a U-shaped channel.

10. The motorcycle wind deflector accessory support of claim 9 wherein the upper rear support element is biased towards a back of the support structure for clamping the wind deflector against the back of the support structure.

11. The motorcycle wind deflector accessory support of claim 1 further comprising a motorcycle wind deflector accessory.

12. The motorcycle wind deflector accessory support of claim 11 wherein the accessory comprises a decorative overlay attached to the support structure for display against or over the wind deflector within the said at least one window.

13. The motorcycle wind deflector accessory support of claim 12 wherein the decorative overlay is attached to the support structure at least two points, and further wherein said at least two points are separated from each other by said at least one window.

14. The motorcycle wind deflector accessory support of claim 13 wherein one of said points is along an upper support member and another of said points is along a lower support member.

15. The motorcycle wind deflector accessory support of claim 12 wherein the decorative overlay is removably attachable to the support structure.

16. The motorcycle wind deflector accessory support of claim 15 wherein the decorative overlay is removably attachable by bolting, screwing, snap fitting, friction fitting, or hook and loop fastening, the decorative overlay to the support structure.

17. The motorcycle wind deflector accessory support of claim 15 wherein the decorative overlay comprises an insert for a cavity in the support structure.

18. The motorcycle wind deflector accessory support of claim 17 wherein the cavity comprises one of said at least one windows and structure to removably retain the insert in the cavity.

19. The motorcycle wind deflector accessory support of claim 11 wherein the accessory comprises an antenna.

20. The motorcycle wind deflector accessory support of claim 19 wherein the antenna is moulded into the accessory support.

21. The motorcycle wind deflector accessory support of claim 19 wherein the antenna is mounted in at least one antenna cavity in the accessory support.

22. The motorcycle wind deflector accessory support of claim 21 wherein said at least one antenna cavity is within a perimeter of the support structure.

23. The motorcycle wind deflector accessory support of claim 21 wherein the antenna is removable and replaceable.

24. The motorcycle wind deflector accessory support of claim 19 wherein at least a part of the antenna is mounted on a surface of the accessory support.

25. The motorcycle wind deflector accessory support of claim 1 wherein the accessory support further comprises a channel, and further wherein an antenna is mounted within said channel.

26. The motorcycle wind deflector accessory support of claim 1 wherein the accessory support further comprises at least one groove in a surface of the accessory support, and further wherein an antenna is mounted within said groove.

27. The motorcycle wind deflector accessory support of claim 11 wherein the accessory comprises lights attached to a visible surface of the accessory support.

28. The motorcycle wind deflector accessory support of claim 27 wherein the lights comprise light emitting diodes.

29. The motorcycle wind deflector accessory support of claim 27 wherein the lights are powered by an electrical system of a motorcycle.

30. The motorcycle wind deflector accessory support of claim 27 wherein the lights are powered by at least one battery that is separate from a remainder of an electrical system of a motorcycle.

31. The motorcycle wind deflector accessory support of claim 27 wherein the accessory further comprises a regulator that regulates the order, frequency or colour of the lights to be powered.

32. The motorcycle wind deflector accessory support of claim 27 wherein the lights comprise one or more than one brake light, running light, or pair of turn signal lights.

33. The motorcycle wind deflector accessory support of claim 32 wherein the lights are recessed in at least one of a front, a rear or a side surface of the accessory support.

34. The motorcycle wind deflector accessory support of claim 32 wherein the accessory support further comprises at least one rear support element, and further wherein at least one of said lights is mounted upon said at least one rear support element.

35. The motorcycle wind deflector accessory support of claim 32 wherein said lights comprise turn signal lights and brake lights and further wherein said lights are powered by a power supply separate from a power supply of a motorcycle and said turn signal lights and said brake lights are operably connected to the motorcycle by RF receivers attached to said lights and RF transmitters attached to the electrical system of the motorcycle.
